(19) United States
(12) Patent Application Publication
(10) Pub. No.: US 2006/0222116 A1
(43) Pub. Date: Oct. 5, 2006

(54) AGC with integrated wideband interferer detection

(75) Inventors: James David Hughes, Boynton Beach, FL (US); Lynn R. Freytag, Deerfield Bch., FL (US); Mahibur Rahman, Lake Worth, FL (US)

Correspondence Address: LAW OFFICE OF CHARLES W. BETHARDS, LLP, P.O. BOX 1622, COLLEYVILLE, TX, 76034, US

(73) Assignee: FREESCALE SEMICONDUCTOR, INC.

(21) Appl. No.: 11/095,274

(22) Filed: Mar. 31, 2005

(51) Int. Cl. H04L 27/08

(52) U.S. Cl. 375/345

(57) ABSTRACT

An automatic gain control (AGC) system for a receiver and corresponding method facilitate AGC in a receiver. The AGC system includes an on-channel detector 123 configured to provide an on-channel automatic gain control (AGC) indication; an off-channel signal detector 145 configured to provide an off-channel AGC indication; and a controller 143, 173 coupled to the on-channel AGC indication and the off-channel AGC indication and configured to provide a gain control signal corresponding to at least one of the on-channel AGC indication and the off-channel AGC indication.

### FIELD OF THE INVENTION

This invention relates in general to communication receivers and more specifically to an automatic gain control (AGC) system including wideband interferer signal detection.

### BACKGROUND OF THE INVENTION

Automatic gain control or AGC systems are known and widely used. However present communications systems being developed and proposed, such as UMTS (Universal Mobile Telephone Systems) also known as WCDMA (Wideband Code Division Multiple Access) when referring to the air interface, are considering relatively high data rates with complex modulation schemes and channel coding schemes each of which is expected to place very stringent demands on the overall AGC system that is used for receivers that will be deployed in these systems. Known AGC systems typically assess on channel signal levels and make gain adjustments accordingly.

Receiver architectures are evolving and due in part to economic pressures, less selectivity is being incorporated in receiver front ends and intermediate frequency (IF) stages. Practitioners are opting instead to incorporate the selectivity in later digital processing stages. Unfortunately that means a broader band of signals may be present in the front ends, IF stages, or analog to digital converter(s) (ADC) (used to convert from analog received signals to the digital domain). The chances that the front ends and particularly later receiver stages such as IF stages or ADCs may be overloaded by a large near band or out of band (off-channel) signal has increased with the reduction in selectivity. This may cause serious overloading conditions (exceeding dynamic range) for cost effective ADCs.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 depicts, in an exemplary receiver, an exemplary embodiment of an automatic gain control (AGC) system according to the present invention;

FIG. 2 shows an exemplary graph of frequency relationships for on-channel and various off-channel signals;

FIG. 3 and FIG. 4 illustrate embodiments of flow charts for a method in an AGC system, such as the system of FIG. 1;

FIG. 5 illustrates a curve of gain control and various simulation data for the AGC system of FIG. 1; and

FIG. 6 and FIG. 7 illustrate measured data indicative of gain control for the AGC system of FIG. 1.

### DETAILED DESCRIPTION

In overview, the present disclosure concerns communications systems and equipment that provide service to communications units or more specifically users thereof operating therein. More particularly various inventive concepts and principles embodied in apparatus and methods for providing automatic gain control (AGC) systems for receivers in communication units, where the AGC systems operate to protect various functions in the receiver from off-channel or out of band signals as well as normal on channel AGC are discussed and described. The systems and receivers of particular interest are those being developed and deployed such as UMTS (Universal Mobile Telecommunication System)/WCDMA (Wideband Code Division Multiple Access) systems and the like as well as extensions, evolutions and so forth for such systems and equipment operating therein, particularly where such systems and equipment co-exist and operate with other systems such as legacy GSM (Global System for Mobile) systems. Note that the concepts and principles according to the present invention, while described in the context of a receiver or UMTS/W-CDMA system, are believed to be applicable in many systems in the digital signal processing field where overload situations may exist due to noise or other undesirable artifacts.

As further discussed below various inventive principles and combinations thereof are advantageously employed to detect off-channel or out-of-band signals that may result in overloading one or more functions, e.g., analog to digital converters (ADCs), and as needed effect a controlled gain reduction in such situations and thus avoid any detrimental impact that may otherwise occur. This inventive AGC system and techniques can be particularly advantageously utilized within an exemplary WCDMA receiver, thereby alleviating various problems associated with known AGC systems and facilitating lower cost higher performance receivers while still providing an autonomous and low power version of an AGC system, provided these principles or equivalents thereof are utilized.

The instant disclosure is provided to further explain in an enabling fashion the best modes of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions.

Much of the inventive functionality and many of the inventive principles are best implemented with or in integrated circuits (ICs) and software or firmware instructions, such as custom or semi-custom ICs, e.g., application specific ICs. It is expected that one of ordinary skill, notwithstanding possibly significant effort and many design choices motivated by, for example, available time, current technology, and economic considerations, when guided by the concepts and principles disclosed herein will be readily capable of generating such instructions and ICs with minimal experimentation. Therefore, in the interest of brevity and minimization of any risk of obscuring the principles and concepts according to the invention, further discussion of such software and ICs, if any, will be limited to the essentials with respect to the principles and concepts of the preferred embodiments

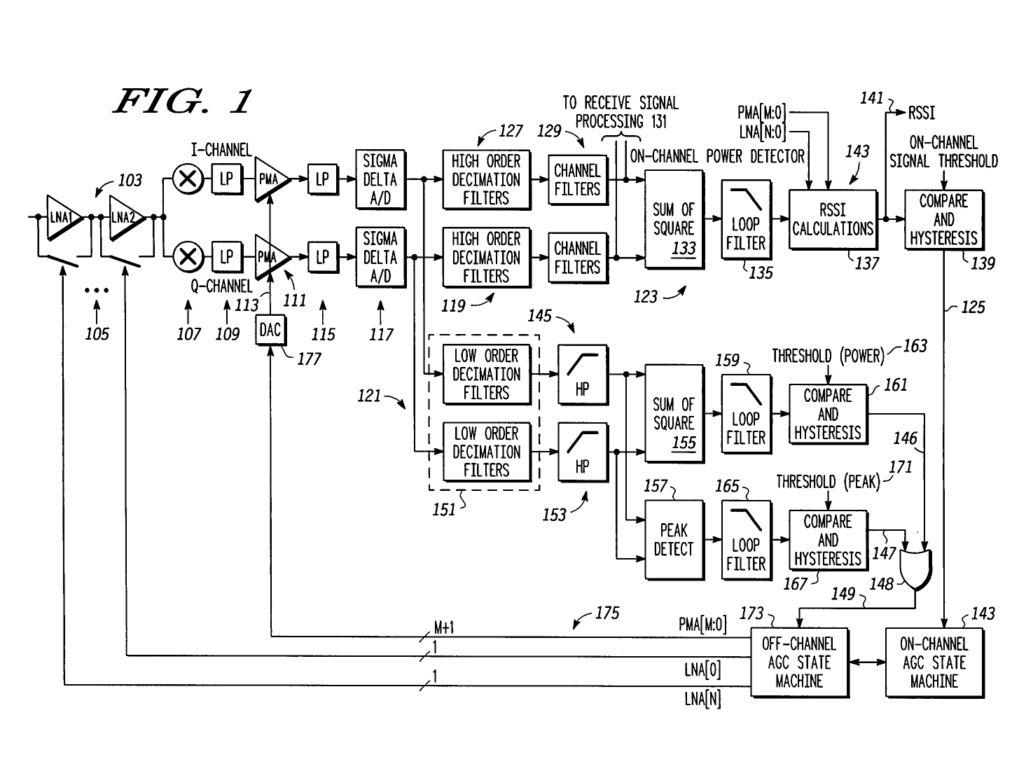

Referring to FIG. 1, a portion of an exemplary receiver including one of various embodiments of an automatic gain control (AGC) system will be discussed and described. The receiver portion of FIG. 1 is a receiver front end from the antenna through channel filters, such as a receiver for WCDMA or UMTS signals or other relatively wide band receiver suitable for high levels of integration and processing complex modulation high data rate signals. The receiver includes or is inter-coupled to a generally known antenna (not shown) at one or more radio frequency (RF) amplifiers or low noise amplifiers (LNAs) 103. The LNA(s) 103 and associated circuitry include a bypass switch arrangement 105 that allows the LNA(s) to be controllably used as an attenuator stage operable to switch a fixed amount, e.g., in one embodiment 18 dB, of attenuation into the receive path. More specifically the switch arrangement when operated foregoes that amount of gain for the received signal. The LNA 103 is coupled at an output to a mixer stage 107 for down conversion of the radio frequency signal to an intermediate frequency (IF) or baseband frequency as is known. The mixer stage is a complex mixer that is driven by a local oscillator (not shown) and provides quadrature signal components, e.g., in phase (I) (upper functions or channel in FIG. 1) and quadrature (Q) (lower functions or channel in FIG. 1) signal components as is known.

From the mixer stage 107 the down converted receiver signal is filtered by a low pass filter 109. Specifically the I channel and Q channel signals are filtered by respective low pass filters 109, such as a resistor capacitor filter with a corner frequency set to accommodate the bandwidth of any signal of interest. The outputs or I and Q channels from the low pass filter 109 are coupled to respective variable gain amplifiers (PMA—post mixer amplifier) 111. The PMA is a variable amplifier that is operable to amplify a received signal in accordance with a gain control signal. The PMA has variable or controllable gain, via a gain control input 113, and can be utilized as a variable attenuator, responsive to a variable control signal, to provide a variable amount of attenuation or gain for the received signal (I and Q channel). The PMA 111 in some embodiments is arranged to provide approximately −30 to +15 db (45 dB range) of attenuation or gain control in nominally 3 dB steps for the I and the Q channel signal. The outputs of the PMAs 111 are coupled to a further low pass filter 115, with one each for the I and Q channel. In one or more embodiments these low pass filters are realized as a 6 dB inverting amplifier with a real pole, two active bi-quad filtering stages with two complex poles and unity gain, and an output buffer. In one exemplary embodiment an analog based integrated circuit includes the mixer stage 107 through the low pass filter 115.

The outputs of the low pass filter 115 are coupled, in one or more embodiments, to a digital integrated circuit that includes Analog to Digital converters, various digital circuitry, and digital signal processing based functionality. Specifically in an exemplary embodiment, the low pass filter 115 outputs are coupled or applied to a analog to digital converter (ADC) 117, with one ADC each for the I and Q channel signal. In one exemplary embodiment suitable for WCDMA receivers, the ADC is a second order sigma delta based ADC that is 12× over sampled (the chip rate for WCDMA signals is 3.84 M chips/second) and provides 6 bit output words at a rate of 46.08 M w/s (million words per second). The output from the ADC 117 is coupled to a normal receive data path 19 and an off-channel processing path 121.

The receive data path 119 includes an on-channel detector 123 that can be arranged and configured to provide an on-channel automatic gain control (AGC) indication, for example, at terminal 125. This on-channel detector 123 can be referred to as an on-channel AGC detector or a narrow band AGC detector. The receive data path 119 includes a high order decimation filter 127 that decimates the I and Q channel signals from the ADC 117. The high order decimation filter in one embodiment decimates the I and Q signals by 3, using known 3 stage cascaded comb filters to provide output signals comprising 14 bit words at a 15.36 MHz rate. The decimation filter 127 provides an I and Q input signal to a channel filter 129, specifically to an I and Q channel filter. The channel filter in one or more embodiments includes known half band type of filters that further decimate the respective input signals by 2. The half band filters are followed by I and Q matched selectivity filters that provide compensation for other filters, etc. in the system and that are running at 7.68 MHz to provide an output signal comprising 13 bit words at 7.68 MHz. The output signal from the channel filter 129 is coupled to additional receive processing 131 (demodulation, error correcting, etc., etc. not relevant to this disclosure) as well as on-channel AGC processes. The composite response of the filtering lineup through the receiver is arranged and configured to provide a square root raised cosine response with a bandwidth suitable for receiving the signal(s) of interest, e.g., 1.92-2.0 MHz for a W-CDMA signal. Note that some or all of the digital filters or other digital signal processing may perform double duty, i.e., can be multiplexed between the I and Q channel signals thus saving some silicon area in an integrated circuit embodiment.

The on-channel AGC processes include in various embodiments an on-channel signal level detector that as shown in exemplary form as an on-channel power detector path. The On-channel Power Detector path samples, filters and integrates incoming I and Q channel signals over a programmable bandwidth and converts the accumulated/normalized value to dB, and then computes a Received Signal Strength Indication (RSSI) value. This information is used to control the gain or attenuation of the PMA 111 and switch in or out the LNA(s) 103 for the given band under “normal” circumstances. The on-channel power detection includes a Sum-of-Squares function 133 that computes the sum of squares (I²+Q²) that is used to compute the detected power or on-channel power level. The Sum-of-Squares function 133 also filters and accumulates the in-band I and Q channel signals or data streams that enter the on-channel AGC. An IIR HP Filter (not specifically shown) is placed before the Sum-of-Squares function 133 and performs programmable high-pass filtering (corner frequency approximately 100 KHz) of the incoming data streams in order to remove any DC offsets that may result from the mixer stage 107 or the like (this insures loop stability).

The Sum-of-Squares function 133 is coupled to a loop filter 135 that is a known Accumulate-and-dump filter that provides an output signal corresponding to an on-channel signal level, e.g., power level. The loop filter 135 in one or more embodiments is set to accumulate approximately 1000 chips (260 micro-seconds). The accumulate time together with feedback delays and data conversion delays allows an update approximately every 270 microseconds. The loop filter to a large extent establishes the on-channel AGC control loop dynamics as will be appreciated by one of ordinary skill. The loop filter output and corresponding signal is coupled to a RSSI calculator 137 that provides an RSSI value to a Compare/Hysteresis function 139 as well as other receive processing functions at 141. Note that the RSSI calculator includes AGC control inputs 143 (further discussed below) that are used to adjust the RSSI value and thus account for any attenuation that is provided by the various gain control stages, e.g., LNA(s) 103 or PMA 111, such that the RSSI value represents the power input at the antenna. The Compare/Hysteresis function 139 compares the on-channel signal level, e.g., on-channel power level, to an on-channel threshold that is programmable. The Compare/Hysteresis function 139 thus checks whether the detected on-channel power satisfies, (above or below) a programmable on-channel threshold to determine if more or less attenuation of, for example, the PMA or LNA is needed. This is reflected in the on-channel AGC indication at terminal 125. It will be appreciated that the on-channel AGC system is required to have some precision. Accordingly the AGC indication at terminal 125 can include both a magnitude and a sign, where the magnitude is indicative of the amount of difference between the RSSI value and the threshold and thus the amount of change in attenuation that may be required. Note that the Hysteresis operates to apply two different thresholds, e.g., a high threshold that when exceeded by the on-channel RSSI value indicates more attenuation is required/appropriate and a lower threshold that when the RSSI is below the lower threshold indicates that less attenuation is needed. By appropriately choosing the high and low thresholds hunting or toggling between different gain or attenuation settings by the on-channel AGC loop can be reduced. The on-channel AGC indication is coupled to an on-channel state machine or controller 143 that will be described below.

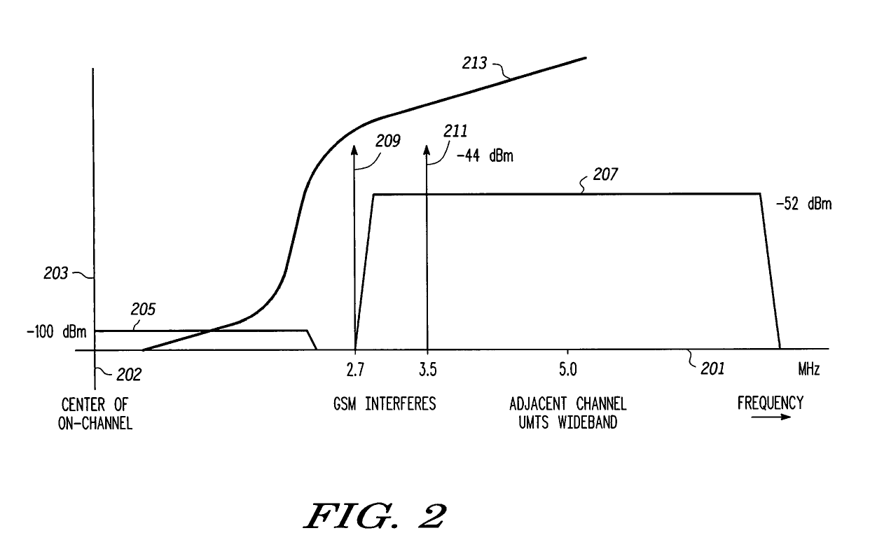

The off-channel processing path 121 includes an off-channel signal detector 145 that is arranged and configured to provide one or more off-channel AGC indications, for example, at terminals 146, 147 or via OR gate 148 at terminal 149. The off-channel signal detector can be referred to as a wideband AGC detector that in one or more embodiments is a digital wideband AGC detector. The wideband detector path samples, filters and integrates the I and Q channel signals from the ADC 117 to provide an assessment of off-channel signal levels, such as signal levels for varying types of interferer signals, e.g., other W-CDMA signals or GSM signals from adjacent channels or other carriers or other interfering signals that may fall within the bandwidth of the receiver system as will be briefly further discussed below with reference to FIG. 2.

The off-channel signal detector comprises a wideband decimation filter that in one embodiment is a low order decimation filter 151, e.g., a filter for each of the I and Q digital signals from the ADC 117. The decimation filter 151, in one embodiment, provides one stage of comb filtering. Note various embodiments can use the interleaved RX_IQ signal after one stage of comb filtering in the high order decimation filter 127. The single stage of decimation filtering allows the off channel signal detector to measure off-channel interferers over a wide bandwidth and thus measure an interferer at 2.7 MHz, 3.5 MHz, or adjacent W-CDMA interferers in the adjacent 5 MHz channel. The outputs from the low order decimation filter 151 are coupled to a high pass filter (HPF) 153. The HPF 153 is an infinite impulse response filter with a corner frequency around 2.5-2.6 MHz. The HPF 153 can be programmable (corner frequency or bandwidths, gains, etc) to high-pass filter the incoming data stream, e.g. I and Q channel signal. The HPF 153 is arranged and configured to suppress or attenuate on-channel signals and thus insure that whatever signal is detected by the off channel detector is an off-channel signal or interferer.

The outputs from the HPF 153 are coupled to a wideband power detector 155 and a wideband peak detector 157. The wideband power detector in one embodiment comprises a Sum-of-Squares function 155. The sum of squares function includes an output coupled to a loop filter 159. These collectively operate in a fashion similar to the on-channel path as discussed above. Note that in various embodiments, the wideband power detector can be advantageously utilized to detect power levels of signals such as adjacent channel W-CDMA signals. The output of the loop filter 159 is coupled to a comparator, e.g., Compare/Hysteresis block 161 that compares the detected power level, e.g., interferer power level, to one or more power or wideband thresholds available at 163 and thus determines based on the wideband interferer thresholds if more or less attenuation of, for example, the PMA is indicated. The Compare/Hysteresis block 161 provides the off-channel AGC indication or off-channel wideband AGC indication corresponding to an off-channel power level at terminal 146.

The wideband peak detector 157 comprises a known peak detector for assessing signal envelope magnitude. An indication of the peak level as detected by the peak detector is coupled to a loop filter 165. The loop filter 165 is similar to and performs similar functions to the loop filter 135. However in one or more embodiments the integrate time is shorter, e.g., 100-500 chips or approximately 25-130 micro-seconds, yielding an update period of approximately 30-135 microseconds. Note that in various embodiments, the wideband peak detector can be advantageously utilized to detect peak levels of signals such as adjacent channel narrow band interferers, for example GSM signals. The output of the loop filter 165 is coupled to a comparator, e.g., another Compare/Hysteresis block 167 that compares the detected peak level, e.g., interferer peak level, to one or more peak or narrow band interferer thresholds available at 171 and thus determines based on the narrow band interferer thresholds whether more or less attenuation of, for example, the PMA 111 is indicated. It should be noted that the peak thresholds can vary from or be independently selected relative to the power thresholds noted above, e.g., in one embodiment the peak thresholds are selected to be approximately 6-12 dB larger than the power thresholds. Note that the loop filters 159, 165 can also have their respective accumulate times independently adjusted or programmed. The Compare/Hysteresis block 167 provides the off-channel wideband AGC indication corresponding to an off-channel peak level at terminal 147. The power and peak based AGC indications are OR'd at OR gate 148 and coupled to an off-channel state machine or controller 173. Note that the controller 173 is inter coupled to the controller 143.

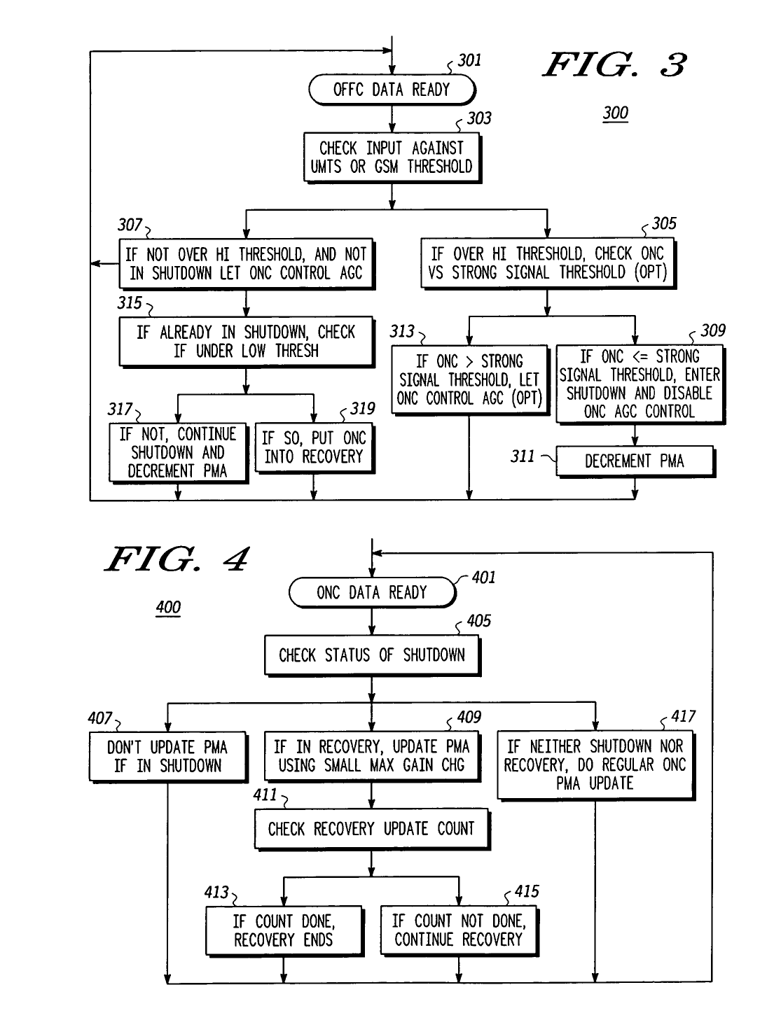

The on-channel controller 143 and off-channel controller 173 are coupled respectively to the on-channel AGC indication and the off-channel AGC indication and collectively function as a controller configured to provide a gain control signal corresponding to the on-channel AGC indication or the off-channel AGC indication. The controller thus comprises an on-channel controller coupled to the on-channel AGC indication and an off-channel controller coupled to the off-channel AGC indication, where the on-channel controller and the off-channel controller are cooperatively operable to provide the gain control signal, specifically a digital gain control signal at 175 that comprises a plurality of control lines (PMA[M:0], LNA[0], . . . LNA[N]. The PMA[M:0] carries a 4 bit control signal to a digital to analog converter (DAC) 177. This control signal is converted to an analog gain control signal by the DAC 177 and this signal is used as a gain control signal 113 to adjust the gain or attenuation of the PMA 111. As will be further discussed below with reference to FIG. 3 and FIG. 4, the on-channel and off-channel controller cooperatively operate in various modes including: on-channel AGC control with or without an off-channel interferer; off-channel AGC control where the on-channel AGC control (at least the PMA portion) is shutdown or disabled although the on-channel AGC detector system continues to operate and provide the RSSI signal noted above and continues to control the LNA 103 in one or more embodiments; and an on-channel AGC recovery mode. For example, the on-channel controller is shutdown and the off-channel controller provides the gain control signal when the on-channel AGC indication corresponds to an on-channel signal that is below an on-channel threshold or in some embodiments above the on-channel threshold and the off-channel AGC indication corresponds to an off-channel signal that is above an off-channel threshold.

Referring to FIG. 2, an exemplary graph of frequency relationships for on-channel and various off-channel signals as seen by the receiver and AGC system of FIG. 1, will be briefly discussed and described. The horizontal axis 201 depicts frequency relative to the center frequency of the on-channel signal 202 while the vertical axis 203 is relative amplitude or power. An on-channel signal 205 can be below −100 dBm (sensitivity of the receiver) and occupies a two sided 3 dB bandwidth of 3.8 to 4.0 MHz with a channel spacing of 5.0 MHz. A similar signal 207, e.g., a UMTS or W-CDMA signal located at an adjacent channel occupies a bandwidth of approximately 4.6 MHz that is centered at a frequency that is 5.0 MHz removed from the center frequency of the on-channel signal and can have an amplitude as high as −52 dBm (i.e. 48 dBm larger than the on-channel signal). Note that this interfering signal can increase dB for dB with the on-channel signal 202 up to −25 dBm. Other signals or interferer signals that may be located relatively close to the on-channel signal are narrow band interferers, such as GSM signals (bandwidth approximately 25 KHz) with one GSM signal 209 shown at 2.7 MHz and another GSM signal 211 shown at 3.5 MHz, each having an amplitude or power as high as −44 dBm (56 dBm higher than the one channel signal). Note there can be additional interferers (not shown). These interfering signals are similarly allowed to rise dB for dB with the on-channel signal. FIG. 2 also depicts an exemplary frequency response curve 213 that is representative of one embodiment of the high pass filter 153. Note that the on-channel signal will be significantly attenuated by the high pass filter while off-channel interferers are not.

FIG. 2 illustrates various problems that may arise in a receiver with little or limited selectivity in front or prior to the ADC 117, namely that the ADC 117 or other earlier or later functionality, that inherently have limited dynamic range due to various factors including economic factors as well as power consumption, size and weight factors, may be overloaded (dynamic range exceeded) by large off-channel interfering signals, such as signals 207, 209, or 211. Since conventional on-channel AGC systems (see 123) must provide with some resolution the received signal strength (RSSI) of the on-channel signal in order to facilitate proper reception of that signal, they are not equipped to deal with off-channel interferers. The on-channel AGC systems are processing narrow band on-channel signals after much or all of the system filtering has occurred (see high order decimation filter 127 and channel filter 129) and therefore do not measure off-channel signals, such as signals 207-211 and thus are not able to avoid or otherwise mitigate any overload conditions that may occur at, for example, the ADC 117. One or more embodiments in accordance with the present invention advantageously address these and other problems. The off-channel signal detector 121, in view of the high pass filter 153 with its frequency response curve 213, specifically assesses the off-channel signal levels and cooperatively with the on-channel AGC system facilitates appropriate gain control for the overall receiver system.

Referring to FIG. 3 and FIG. 4, flow charts of methods in an AGC system, in accordance with one or more embodiments, such as the system of FIG. 1, will be discussed and described. Although these methods will be discussed with reference to FIG. 1 when a context is appropriate, it will be appreciated that the methods may be practiced in the FIG. 1 system and they may also be embodied in or practiced by other suitably configured apparatus, provided concepts or principles in accordance with the discussion below are utilized.

FIG. 3 and FIG. 4 illustrate methods 300, 400 of facilitating automatic gain control (AGC) in a receiver. The method includes providing an on-channel AGC indication (401 corresponds to RSSI data from 137) and an off-channel AGC indication (301 corresponds to output data from 159 or 165); selecting at least one of the on-channel AGC indication and the off-channel AGC indication; and providing, responsive to the selecting, a gain control signal that is dependent on the at least one of the on-channel AGC indication and the off-channel AGC indication. Note that given the respective AGC data or indication the balance of FIG. 3 and FIG. 4 are largely devoted to particulars of selecting the appropriate data or indication and providing a proper gain control signal dependent on that selection and other specifics as will be further discussed below. Note that the on-channel AGC data or indication may be greater or less than a strong signal threshold (a large on-channel signal that alone may result in an overload condition) or greater or less than a normal (e.g., lower) on-channel threshold. Note also that the off-channel data or AGC indication may be greater or less than a HI threshold (power or peak) indicating a large off-channel signal or interferer may be present or greater or less than a LOW threshold indicating the large off-channel signal may no longer be present. The various methods or processes of FIG. 3 and FIG. 4 cooperatively operate to provide an appropriate gain control signal depending on the various states of the on-channel and off-channel AGC data or indication.

Referring to FIG. 3, a process devoted to an off-channel AGC system including a corresponding controller (e.g., off channel detector 121 and off-channel controller 173) is illustrated. Initially it is determined whether the off channel data is ready 301. This data will be made available as a result of high pass filtering a receiver signal from an output of an ADC to provide, for example, an interferer signal. This also allows for sufficient time (feed back delay, filter accumulate times, data translation, etc.) for any new data resulting from a last AGC gain control update or the like to be available at the output of the loop filter(s) 159, 165. This off-channel or input data (output of filter 159, 165) is checked against or compared to various thresholds, e.g., data representative of an off-channel power level of an interferer (e.g., corresponding to a W-CDMA or UMTS signal) is compared to power thresholds, and concurrently data representative of an off-channel peak level of an interferer (e.g., corresponding to a GSM signal) is compared to peak thresholds. Based on this check or comparison the path to 305 or the path to 307 is followed.

Suppose that the off-channel AGC data or indication exceeds the HI threshold and thus a strong off-channel signal, e.g., an interferer, is present, thereby suggesting a decrease in gain in, for example, the PMA, is appropriate. At 305, under these circumstances, optionally the method first checks to see whether the on-channel data or AGC indication satisfies, e.g., exceeds, a strong signal threshold (on-channel signal is large enough to over load the ADC or other functionality). If the on-channel data is less than or equal to a strong signal threshold, one or more embodiments initiate or enter a shutdown process and will normally disable on-channel AGC control of the PMA 309. In any event, 311 indicates that the PMA (or other controllable gain) is decremented (under off-channel AGC control) and the method repeats from 301. Thus the providing the on-channel AGC indication and the off-channel AGC indication further comprises, in one or more embodiments, providing an off-channel AGC indication corresponding to an interferer satisfying an off-channel or HI threshold and optionally providing an on-channel indication corresponding to an on-channel signal not satisfying a strong signal threshold. In this event, the selecting further comprises selecting the off-channel AGC indication; and the providing the gain control signal further comprises providing the gain control signal responsive to the off-channel AGC indication.

If the on-channel AGC data or indication satisfies the strong signal threshold, optionally 313 shows the on-channel control of the AGC system continuing. Thus, the providing the on-channel AGC indication and the off-channel AGC indication further comprises providing an on-channel indication corresponding to an on-channel signal satisfying an on-channel strong signal threshold. In these embodiments, the selecting further comprises selecting the on-channel AGC indication and the providing the gain control signal further comprises providing the gain control signal responsive to the strong signal AGC indication (strong signal RSSI less normal threshold). Note that when the off-channel AGC indication corresponds to an interferer satisfying one of the off-channel thresholds, the off-channel AGC system will ordinarily control and provide the gain control signal, regardless of the on-channel AGC indicator. The exception is when, optionally, the on-channel AGC indicator satisfies a large signal threshold.

Note that off-channel AGC control and disabling on-channel AGC control requires interaction and cooperative functionality between the process of FIG. 3 and that of FIG. 4 as we will discuss further below. In FIG. 1 this interaction or cooperative functionality is provided between the off-channel and on-channel controller 173, 143 as depicted. Note that even when the on-channel AGC control is disabled, the RSSI calculation function continues to operate and provide RSSI data 141 and further that the LNA is normally under on-channel AGC control in various embodiments.

In FIG. 1, decrementing the PMA or the like implies that a signal on PMA[M:0] (or LNA[M], . . . , LNA[0]) is provided to thereby adjust the gain of the PMA as will be appreciated. Note that various embodiments may find it advantageous to decrement the PMA or the like using small gain reduction steps, e.g., 3 dB, when the off-channel AGC system is controlling the receiver gain, thereby avoiding over-compensation of the receiver gain and improper operation of the receiver for on-channel signal reception. In essence, this is the shutdown process noted above. This may also allow for the use of lower cost and possibly less accurate off-channel detectors.

Suppose the off-channel data or AGC indication does not exceed the HI threshold (peak or power threshold) and the AGC on-channel PMA control system is not in shutdown, then the on-channel AGC system is deferred to for AGC control 307 and the method continues from 301. If the AGC method is already in shutdown (see 309), then at 315, the off-channel data is compared to a LOW threshold 315 (4 dB-6 dB less than HI threshold in some embodiments). As noted above the HI and LOW thresholds are part of the Hysteresis functions 161, 167. If the off-channel AGC indication or data is not less than the LOW threshold then continue the shutdown processes 317, e.g. continue disabling of the on-channel AGC PMA control and decrement PMA. If the off-channel AGC data is less than the LOW threshold then put the on-channel AGC processes in a recovery mode, i.e. enable the on-channel AGC control but only allow small gain changes, possibly at faster rate than would be normal. Thus, the method of FIG. 3 essentially repeats the providing the gain control and decrementing the PMA until the off-channel AGC indication no longer satisfies the off-channel threshold (taking Hysteresis into account) and then initiates or enables a recovery mode wherein the on-channel AGC control is enabled and the providing the gain control signal is responsive to the on-channel AGC indication. This will become clearer given the discussion of FIG. 4 below.

Referring to FIG. 4, another flow chart for a method in an AGC system, such as that of FIG. 1 will be discussed and described. The method begins at 401 with providing an on-channel AGC indication or data, i.e., is the data at the output of the RSSI calculation function 137 available, for example, any updates to the gain control signals, etc. have been made and loop filter has had time to accumulate new data. At 405, a status of the on-channel AGC system is checked. The on-channel AGC system may be in shutdown, e.g., on-channel AGC PMA control is disabled (from 309) and in this event no update for the PMA or the like is provided by the on-channel AGC 407. The on-channel AGC system may be in recovery 409 and in this event the gain control signal is provided in accordance with the on-channel AGC indication, however only a small max gain change (3 dB in some embodiments) is allowed at any one time until the recovery process is over. Basically in one or more embodiments, the recovery phase is a predetermined maximum number of counts or loops, e.g., 4-10 counts, through the process or method 400. If the method is in recovery, 411 shows checking the recovery count and if it equals the predetermined number the recovery phase or process is over 413 and the process continues from 401. If the recovery count is less than the predetermined number 415 the count is incremented, the recovery continues, and the method continues from 401. Note that the time between updates can be changed via programming, for example, of the accumulate time of the loop filter 135. If the on-channel AGC process or system is not in shutdown or in recovery 417, then the normal on-channel AGC control takes place, i.e., the on-channel AGC indication or data is selected and the gain control signal is provided responsive to the on-channel AGC indication. Note that when the on-channel AGC system is not in recovery step sizes that are much larger (e.g., 10-15 dB) than the small max gain change (3 dB in some embodiments) are allowed.

The above discussion, referencing FIG. 1 through FIG. 4, has described various inventive concepts and principles for an AGC system that may be advantageously implanted for example as an integrated circuit for facilitating automatic gain control (AGC) for a receiver. The integrated circuit includes a narrow band AGC detector 123, a digital wideband AGC detector 145, and a controller 143, 173 that is coupled to the narrow band AGC detector and the digital wideband AGC detector and configured to provide a gain control signal. The integrated circuit may further include a controllable gain amplifier (PMA 111 with a control input 113 coupled to the gain control signal, an input coupled to a receiver signal, and an output arranged to provide the receiver signal at a level adjusted by the gain control signal and an analog to digital converter (ADC) 117 with an input coupled to the output of the controllable gain amplifier. In various embodiments, the narrow band AGC detector further comprises a narrow bandwidth filter (combination of filters 127, 129) coupled to an output of the ADC and an on channel signal level detector 123 and the digital wideband AGC detector further comprises a wide bandwidth filter 151 coupled to the output of the ADC, a high pass filter 153 coupled to an output of the wide bandwidth filter and an off channel interferer level detector 155, 157.

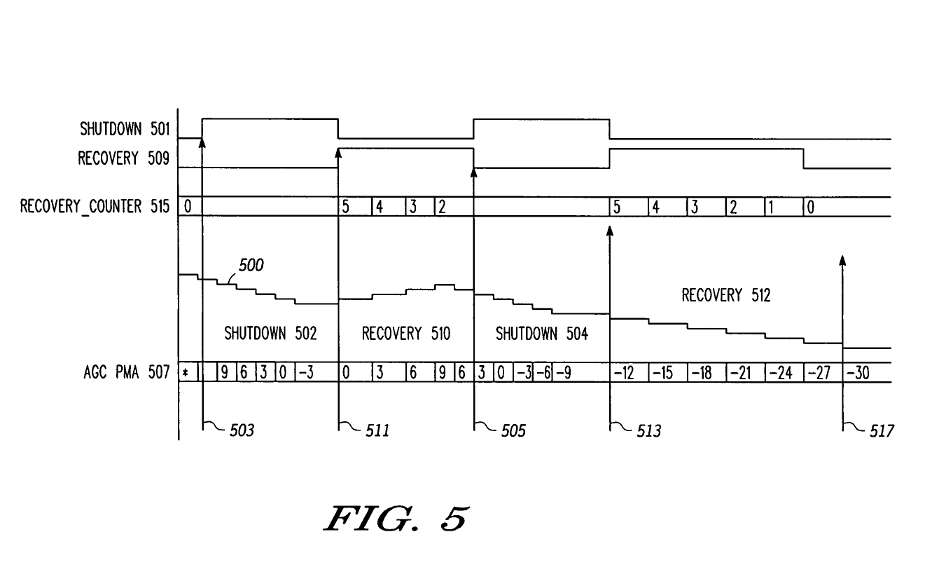

Referring to FIG. 5, various simulation results show a gain control curve 500 for the AGC system of FIG. 1. In this graph a shutdown signal or flag 501 is set to “1” when a shutdown process 502, 504 is initiated 503, 505. This shutdown is caused by a large off-channel signal or interferer being present. Note that in shutdown the gain of the PMA 507 is reduced in 3 dB steps (can be programmed in some embodiments). For example in the first shutdown, the gain is reduced from 12 dB to −3 dB in 5 steps.

A recovery flag 509 or signal is set to “1” and the shutdown flag or signal 501 is set to “0” when a recovery process 510, 512 is initiated 511, 513. Thus the first recovery begins and a small max gain change (3 dB) is used to slowly increase the gain of PMA from −3 to 6 dB. Note that in recovery the steps may be positive or negative. Note also that the recovery count 515 during the first recovery process 510 is reduced from 5 to 2. This recovery is interrupted by presumably another off-channel interferer signal at 505 and the second shutdown process begins 505. The second recovery 512 starts at 513, however in this case the PMA gain is further reduced from −9 to −27, the counter is reduced from 5 to 0, the recovery flag is set to “0” and normal on-channel AGC control is started at 517, where normal control allows for larger gain change steps.

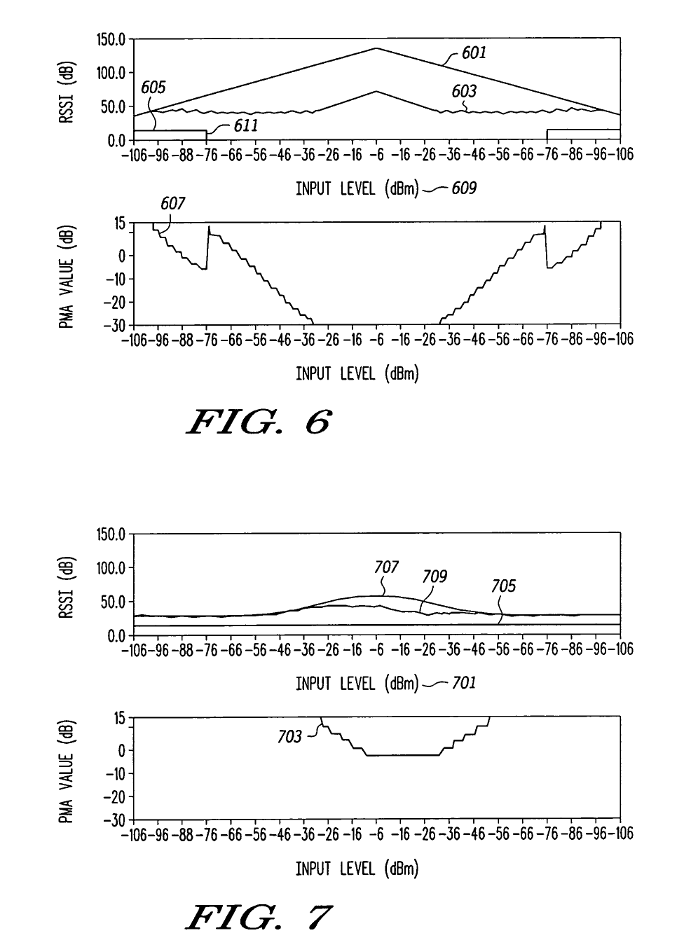

Referring to FIG. 6, additional curves indicative of on-channel gain control for the AGC system of FIG. 1 will be discussed and described. FIG. 6 shows indicated signal level (RSSI value) 601, actual signal level at the RSSI calculation input 603, LNA gain control signal 605, and PMA gain 607, as a function of on-channel input signal level 609. Note that as the input signal level rises the gain of the PMA is reduced. When the LNA is bypassed 611 (gain control signal goes to zero) gain substitution takes place and the PMA gain increases. Once all available gain control or attenuation has taken place the signal level at the RSSI calculator input increases 603.

Referring to FIG. 7, additional curves indicative of off-channel gain control for the AGC system of FIG. 1 will be discussed and described. FIG. 7 shows a situation where a signal that is 10 MHz off-channel is increased in amplitude (horizontal axis 701) to the point that an overload occurs at the ADC. The wideband or off-channel detector responds and reduces the gain of the PMA 703. The LNA is not shut down or bypassed 705 and the RSSI signals 707 (output of RSSI calculation), 709 (input to RSSI calculation) experience a limited increase.

An automatic gain control system for a receiver that is arranged and constructed to provide gain control to mitigate the impact of off-channel interferers in a receiver with limited protection against such interferers has been discussed and described. Generally the automatic gain control advantageously uses a conventional on-channel AGC detector as well as an off-channel AGC detector and controllers that cooperatively operate to provide an appropriate gain control signal when an interferer is present and when such an interferer is not present.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. An automatic gain control system for a receiver comprising:
an on-channel detector configured to provide an on-channel automatic gain control (AGC) indication;
an off-channel signal detector configured to provide an off-channel AGC indication; and
a controller coupled to the on-channel AGC indication and the off-channel AGC indication and configured to provide a gain control signal corresponding to at least one of the on-channel AGC indication and the off-channel AGC indication.

2. The automatic gain control system of claim 1 wherein the off-channel signal detector further comprises at least one of a wideband power detector and a wideband peak detector.

3. The automatic gain control system of claim 1 wherein the off-channel signal detector further comprises a wideband decimation filter coupled to a digital signal from an analog to digital converter.

4. The automatic gain control system of claim 3 wherein the off-channel signal detector further comprises a high pass filter configured to suppress on-channel signals.

5. The automatic gain control system of claim 1 wherein the off-channel signal detector further comprises a comparator for comparing at least one of an interferer power level to a wideband threshold and an interferer peak level to a narrow band threshold.

6. The automatic gain control system of claim 1 wherein the controller further comprises an on-channel controller coupled to the on-channel AGC indication and an off-channel controller coupled to the off-channel AGC indication, the on-channel controller and the off-channel controller cooperatively operable to provide the gain control signal.

7. The automatic gain control system of claim 6 wherein the on-channel controller is shutdown and the off-channel controller provides the gain control signal when the on-channel AGC indication corresponds to an on-channel signal that is below an on-channel threshold and the off-channel AGC indication corresponds to an off-channel signal that is above an off-channel threshold.

8. The automatic gain control system of claim 6 further comprising a variable gain amplifier operable to amplify a received signal in accordance with the gain control signal.

9. A method of facilitating automatic gain control (AGC) in a receiver, the method comprising:
providing an on-channel AGC indication and an off-channel AGC indication;
selecting at least one of the on-channel AGC indication and the off-channel AGC indication; and
providing, responsive to the selecting, a gain control signal that is dependent on the at least one of the on-channel AGC indication and the off-channel AGC indication.

10. The method of claim 9 wherein:
the providing the on-channel AGC indication and the off-channel AGC indication further comprises providing an off-channel AGC indication corresponding to an interferer satisfying an off-channel threshold and providing an on-channel indication corresponding to an on-channel signal not satisfying an on-channel threshold;
the selecting further comprises selecting the off-channel AGC indication; and
the providing the gain control signal further comprises providing the gain control signal responsive to the off-channel AGC indication and disabling at least in part on-channel AGC control.

11. The method of claim 10 further comprising repeating the providing the gain control until the off-channel AGC indication no longer satisfies the off-channel threshold; and then enabling a recovery mode wherein the on-channel AGC control is enabled and the providing the gain control signal is responsive to the on-channel AGC indication.

12. The method of claim 9 wherein:
the providing the on-channel AGC indication and the off-channel AGC indication further comprises providing an off-channel AGC indication that satisfies an off-channel threshold;
the selecting further comprises selecting the off-channel AGC indication; and
the providing the gain control signal further comprises providing the gain control signal responsive to the off-channel AGC indication.

13. The method of claim 12 wherein the providing the on-channel AGC indication and the off-channel AGC indication further comprises providing an on-channel AGC indication that satisfies an on-channel threshold.

14. The method of claim 12 wherein the providing the on-channel AGC indication and the off-channel AGC indication further comprises providing an off-channel AGC indication corresponding to an interferer satisfying at least one of a power threshold and a peak threshold.

15. The method of claim 9 wherein the providing the off-channel AGC indication further comprises high pass filtering a receiver signal at the output of an analog to digital converter to provide an interferer signal and comparing at least one of an off-channel power level of the interferer signal and an off-channel peak level of the interferer signal to a corresponding threshold.

16. The method of claim 15 wherein the comparing the off-channel power level of the interferer signal further comprises comparing the off-channel power level to a threshold corresponding to a Wideband Code Division Multiple Access (W-CDMA) interferer signal.

17. The method of claim 9 wherein the comparing the off-channel peak level of the interferer signal further comprises comparing the off-channel peak level to a threshold corresponding to a Global System for Mobile communication (GSM) interferer signal.

18. An integrated circuit for facilitating automatic gain control (AGC) for a receiver, the integrated circuit comprising:
a narrow band AGC detector;
a digital wideband AGC detector; and
a controller coupled to the narrow band AGC detector and the digital wideband AGC detector, the controller configured to provide a gain control signal.

19. The integrated circuit of claim 18 further comprising:
a controllable gain amplifier with a control input coupled to the gain control signal, an input coupled to a receiver signal, and an output arranged to provide the receiver signal at a level adjusted by the gain control signal; and
an analog to digital converter (ADC) with an input coupled to the output of the controllable gain amplifier.

20. The integrated circuit of claim 18 wherein:
the narrow band AGC detector further comprises a narrow bandwidth filter coupled to an output of the ADC and an on channel signal level detector; and
the digital wideband AGC detector further comprises a wide bandwidth filter coupled to the output of the ADC, a high pass filter coupled to an output of the wide bandwidth filter and an off channel interferer level detector.
